(19) United States
(12) Patent Application Publication
(10) Pub. No.: US 2015/0160356 A1
(43) Pub. Date: Jun. 11, 2015

(54) LAND SEISMIC SENSOR DEPLOYMENT

(71) Applicant: WESTERNGECO L.L.C., Houston, TX (US)

(72) Inventors: Seth Ian Friedly, Asker (NO); Einar Holst, Asker (NO)

(21) Appl. No.: 14/562,953

(22) Filed: Dec. 8, 2014

Related U.S. Application Data
(60) Provisional application No. 61/913,414, filed on Dec. 9, 2013.

(51) Int. Cl. G01V 1/16; E21B 7/26

(52) U.S. Cl. CPC G01V 1/168; E21B 7/26

(57) ABSTRACT

An apparatus includes a driver, a guide and an actuator. The guide holds a seismic sensor device and directs the seismic sensor device along a predetermined trajectory. The actuator produces a force on the driver to push the seismic sensor unit into a ground surface according to the predetermined trajectory.

### CROSS-REFERENCE TO RELATED APPLICATIONS

This application claims benefit of U.S. provisional patent application Ser. No. 61/913,414, filed Dec. 9, 2013 and titled LAND SEISMIC SENSOR DEPLOYMENT METHOD, the entire disclosure of which is herein incorporated by reference.

### BACKGROUND

Seismic exploration may involve surveying subterranean geological formations (e.g., for hydrocarbon and/or other deposits). A survey may involve deploying seismic source(s) and seismic sensors at predetermined locations. The sources generate seismic waves, which propagate into the geological formations creating pressure changes and vibrations along their way. Changes in the elastic properties of the geological formation scatter the seismic waves, changing their direction of propagation and other properties. Part of the energy emitted by the sources reaches the seismic sensors. Some seismic sensors are sensitive to pressure changes (e.g., hydrophones) and others are sensitive to particle motion (e.g., geophones). Industrial surveys may deploy only one type of sensor or both. In response to the detected seismic events, the sensors generate electrical signals to produce seismic data. Analysis of the seismic data can then indicate the presence or absence of probable locations of hydrocarbon or mineral deposits.

A land-based seismic system may include an array of seismic sensors, which are deployed in the ground. A marine survey system may include a towed seismic streamer containing sensors, a seabed cable containing sensors or another arrangement of seismic sensors on the sea floor.

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

In accordance with an example implementation, a technique includes using a machine to form a hole in a ground surface and using a machine to push a seismic sensor device into the hole.

In accordance with another example implementation, an apparatus includes a driver, a guide and an actuator. The guide holds a seismic sensor device and directs the seismic sensor device along a predetermined trajectory. The actuator produces a force on the driver to push the seismic sensor unit into a ground surface according to the predetermined trajectory.

Advantages and other features will become apparent from the following drawings, description and claims.

### BRIEF DESCRIPTION OF THE DRAWINGS

FIG. 1 is a schematic diagram of a seismic survey environment according to an example implementation.

FIG. 2 is a perspective view of a sensor device according to an example implementation.

FIG. 3 is a schematic diagram of a sensor device deployment system according to an example implementation.

FIGS. 4A, 4B, 4C and 4D are illustrations of a sequence to use a sensor device deployment system to deploy a sensor device according to an example implementation.

FIGS. 5A, 5B and 8 are flow diagrams depicting techniques to deploy a sensor device according to example implementations.

FIG. 6 is a perspective view of a sensor device deployment system according to an example implementation.

FIG. 7 is a perspective view of a sensor device according to an example implementation.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “example embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Coupled” and “connected” and their derivatives are not synonyms. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

In seismic surveying (marine or land-based seismic surveying), seismic sensors are used to measure seismic data, such as displacement, velocity, or acceleration. Seismic sensors can include geophones, accelerometers, microelectromechanical systems (MEMS) sensors, or any other type of sensors that measure translational motion of the surface in one or more directions. In the ensuing discussion, a seismic sensor that measures translational motion is referred to as a particle motion sensor. A particle motion sensor can refer to any of the sensors listed above.

An arrangement of particle motion sensors can be provided at (or proximate) a ground surface or earth surface (land surface or bottom surface of a body of water, such as a seafloor) to measure seismic waves reflected from a subterranean structure, in response to seismic waves (or impulses) produced by one or more seismic sources and propagated into an earth subsurface. A particle motion sensor provided at a ground surface can refer to a particle motion sensor that is placed in contact with the ground surface, partially buried in the ground surface, or completely buried in the ground surface up to a predetermined depth (e.g. up to a depth of less than 5 meters). A particle motion sensor at (or proximate) the Earth surface can record the vectorial part of an elastic wavefield just below the free surface (i.e. ground surface).

A significant portion of cost associated with operating a land seismic crew is related to the amount of time and manpower that are used to deploy and retrieve the seismic hardware. In this manner, the seismic hardware may include seismic sensor containing devices (called “seismic sensor assemblies” or “seismic sensor devices” herein), which are placed in the ground surface as well as associated recording units, cabling, and so forth. Systems and techniques are disclosed herein for purposes of automatically deploying seismic sensor devices, which may significantly reduce crew manpower and reduce the cost associated with operating a crew. Additionally, the systems and techniques that are disclosed herein may improve the quality of sensor device placement. In this manner, automatic deployment systems and techniques are disclosed herein to deploy seismic sensor devices at a certain orientation (an orientation in which the elongated axis of the seismic sensor device is within a few degrees of vertical, for example). By using automatic deployment systems and techniques, as disclosed herein, placement of the sensor devices may be better controlled.

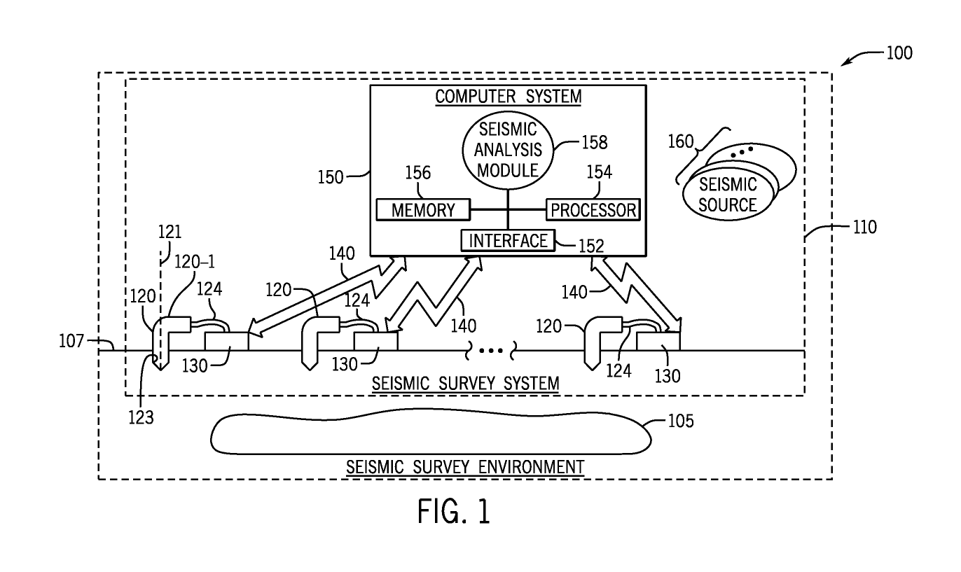

As a more specific example, FIG. 1 depicts a seismic survey environment 100 in accordance with an example implementation. In general, the seismic survey environment 100 includes a land-based seismic survey system 110, which includes seismic sensor containing assemblies, or devices, (called “sensor devices 120” herein). The sensor devices 120 are deployed, or planted, in a ground surface 107 (i.e., the Earth surface) for purposes of sensing energy due to interaction of seismic source energy with a reservoir 105 of interest. The seismic survey system 110 may contain one or multiple seismic sources 160, such as impulse sources or vibroseis sources.

For the example implementation depicted in FIG. 1, each sensor device 120 has an associated recording unit 130. In accordance with some implementations, a given recording unit 130 records seismic data acquired by an associated sensor devices 120. For the example implementations that are discussed herein, each recording unit 130 records data acquired by one sensor device 120, although a given recording unit 130 may record data acquired by multiple sensor devices 120, in accordance with further example implementations.

Moreover, in accordance with example implementations, the recording units 130 may communicate with a computer system 150 as the survey is being conducted. In this manner, FIG. 1 depicts communication links 140 between the recording units 130 and the computer system 150. As an example, the recording units 130 may communicate acquired sensor data in real time or near real time as the survey progresses. In accordance with further example implementations, the recording units 130 may communicate quality control (QC) data to the computer system 150. In yet further example implementations, the recording units 130 may not communicate with a computer system during the survey, but rather the recording units 130 may store acquired data so that the data may be retrieved from the units 130 at a later time.

For the example implementation depicted in FIG. 1, a cable 124 couples a given seismic sensor device 120 to its associated recording unit 130. Depending on the particular implementation, the cable 124 may communicate seismic data and/or power to the associated sensor device 120.

In accordance with example implementations, the computer system 150 may be a processor-based system that includes, a processor 154 (a central processing unit (CPU), for example), a memory 156 and an interface 152. In this regard, the interface 152 may be a wireless interface, a network interface, and so forth, for purposes of receiving QC data, sensor data, and so forth from the recording units 130. The memory 156, in general, forms non-transitory storage for purposes of storing configuration information, acquired data, program instructions, and so forth, for the computer system 150. The memory 156 may, in particular, store instructions that when executed by the processor 154 causes the processor to perform a seismic analysis module 158 for purposes of analyzing the acquired seismic data and/or QC data.

In accordance with example implementations, the seismic sensor device 120 includes an outer housing that contains one or multiple seismic sensors that are disposed therein, such as particle motions sensors (accelerometers, velocity sensors, and so forth), hydrophones (pressure sensors), pressure gradient sensors, rotation sensors or a combination of one or more of these sensors. Moreover, the seismic sensor device 120 may include non-seismic measurement acquiring sensors, such as inclinometers (i.e., a tilt sensor). The seismic sensor device 120 may include other non-seismic sensor components, such as a compass, a battery, a fuel cell, a radio frequency (RF) radio for wireless communication, a global positioning satellite (GPS) radio, a wired communication interface, a memory, a controller, a power regulation system, and so forth.

As depicted in FIG. 1, the seismic sensor devices 120 are inserted, or planted, in corresponding holes 123 in the ground surface 107. As illustrated for the seismic sensor device 120-1, the seismic sensor 120 has an elongated axis 121 that is ideally vertical or near vertical (within ten degrees of being vertical, for example).

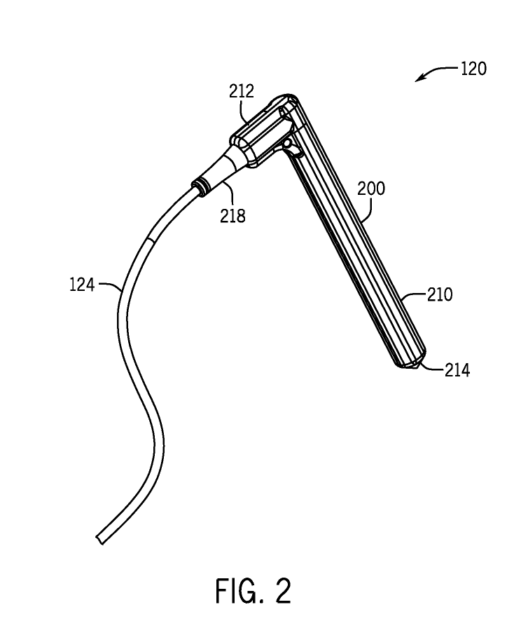

Referring to FIG. 2 in conjunction with FIG. 1, in accordance with some implementations, the seismic sensor device 120 includes an L-shaped housing 200 which has a longer section 210 that has a point 214 at its lower end to form a corresponding spike for the seismic sensor device 120. In this regard, the spike portion is inserted into the hole 123 to anchor the device 120 in place, as illustrated in FIG. 1. The seismic sensor device 120 further includes a shorter section 212 of the housing 200, which diverges at an approximate 90° angle relative to the section 210 to establish an angled connection for connecting the sensor device 120 to the cable 124. The cable 124 may be coupled to the shorter section 212 of the housing 200 via a strain relief grommet 218, and the cable 124 may be hermetically-sealed to the housing 200 using overmoulding contained in the shorter section 212 of the housing 200, in accordance with example implementations.

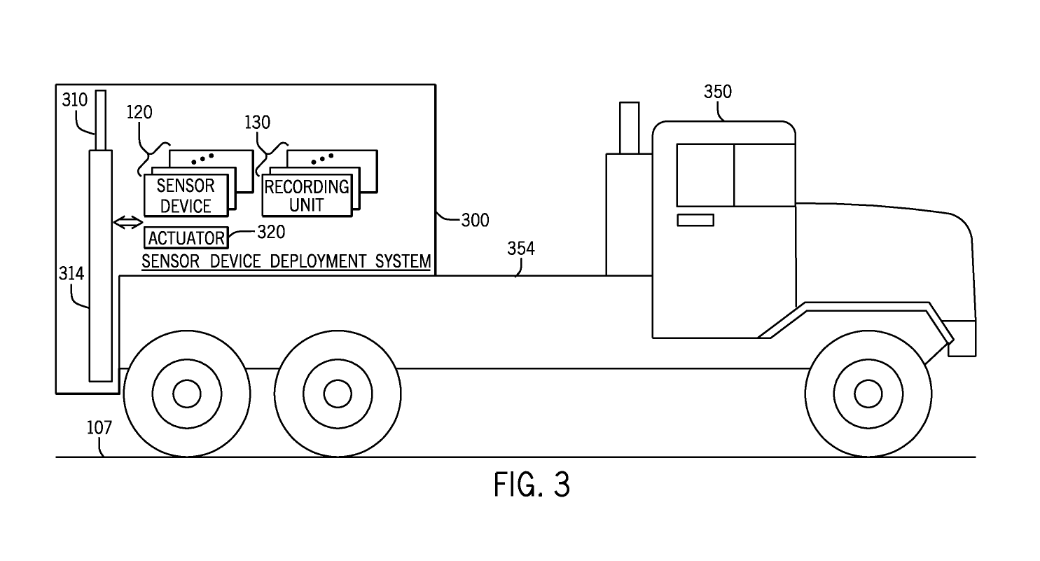

Referring to FIG. 3, in accordance with example implementations, a sensor device deployment system 300 may be used to deploy the seismic sensor devices 120 into the ground surface 107 in an automated fashion. The sensor device deployment system 300 may be mobile in that the system 300. In this manner, in accordance with example implementations, the sensor device deployment system 300 may be mounted to a vehicle, such as a truck 350 (mounted on a bed 354 of the truck 350, for example).

As schematically depicted in FIG. 3, the seismic sensor devices 120 and their associated recording units 130 are stored in the sensor device deployment system 300 before their deployment, and according to example implementations, the sensor device deployment 300 serially deploys sets of the sensor devices 120 and recording units 130. In this manner, in accordance with example implementations, the sensor device deployment system 300 deploys a set of an individual sensor device 130 and an associated individual recording unit 300 at each individual sensor location.

More specifically, in accordance with example implementations, as the truck 350 moves from one sensor device location to the next (via global positioning satellite (GPS)-based guidance, for example), another seismic sensor unit 120 is deployed in a guide 314 of the sensor deployment system 300, and a driver 310 of the sensor deployment system 300 is actuated (via an actuator 320, for example) for purposes of driving the sensor device 120 into the ground surface 107. As described herein, before the seismic sensor unit 120 is loaded into the guide 314, the sensor deployment system 300 may undertake measures to create a hole in the surface 107.

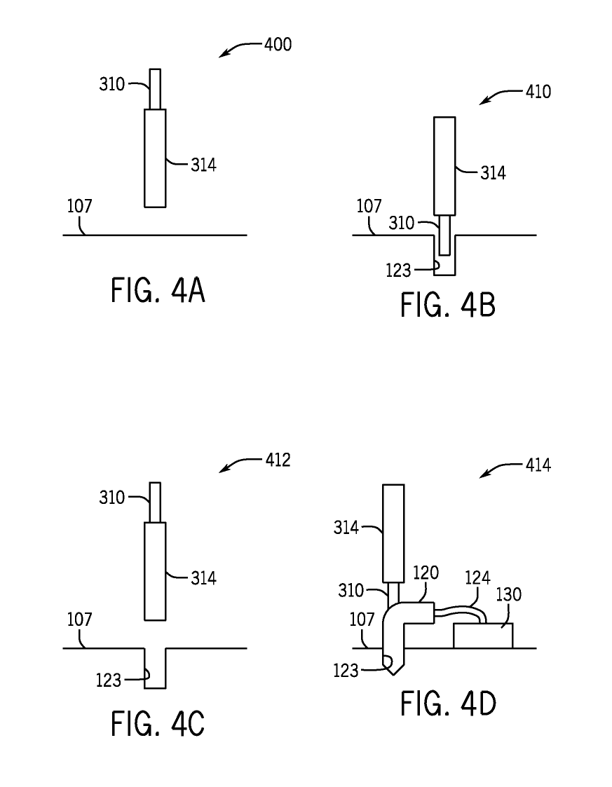

More specifically, an example process of creating a hole and driving a seismic sensor device 120 into the hole is illustrated in FIGS. 4A, 4B, 4C and 4D. Referring to FIG. 4A, to prepare the ground surface 107 for the deployment of the seismic sensor 120, an initial preparation stage 400 includes positioning the guide 314 at the next sensor location. In this regard, the truck 350 (FIG. 3) may be driven to precisely position the guide 314 at the next sensor location (via GPS-based navigation, for example). As depicted in FIG. 4A, for the initial stage 400, the driver 310 is raised.

Referring to FIG. 4B, for a second stage 410, the actuator 320 (FIG. 3) is actuated to exert a generally downwardly acting force to drive, or push, the driver 310 into the surface 107 to form the hole 123. The guide 314 guides the driver 310 so that corresponding hole 123 is vertical or near vertical.

For a next stage 412 depicted in FIG. 4C, the actuator 320 (FIG. 3) is actuated to apply a reverse-acting force to lift the driver 310 out of the hole 123 and prepare the sensor deployment system 300 for the next stage. In this manner, referring to FIG. 4D, for the next stage 414, the sensor device 120 is loaded into the guide 314, and the actuator 320 is subsequently actuated to exert a force to push the driver 310 and sensor device 120 (disposed at the lower end of the driver 310) into the hole 123. As also depicted in FIG. 4D, the associated recording unit 130 and cable 124 are also simultaneously deployed with the newly-installed sensor device 120. The truck 350 (FIG. 3) may then be moved to the next sensor location, leaving the seismic sensor unit 120, cable 124 and recording unit 130 behind. Depending on the particular implementation, additional cabling may be connected to the recording unit 130.

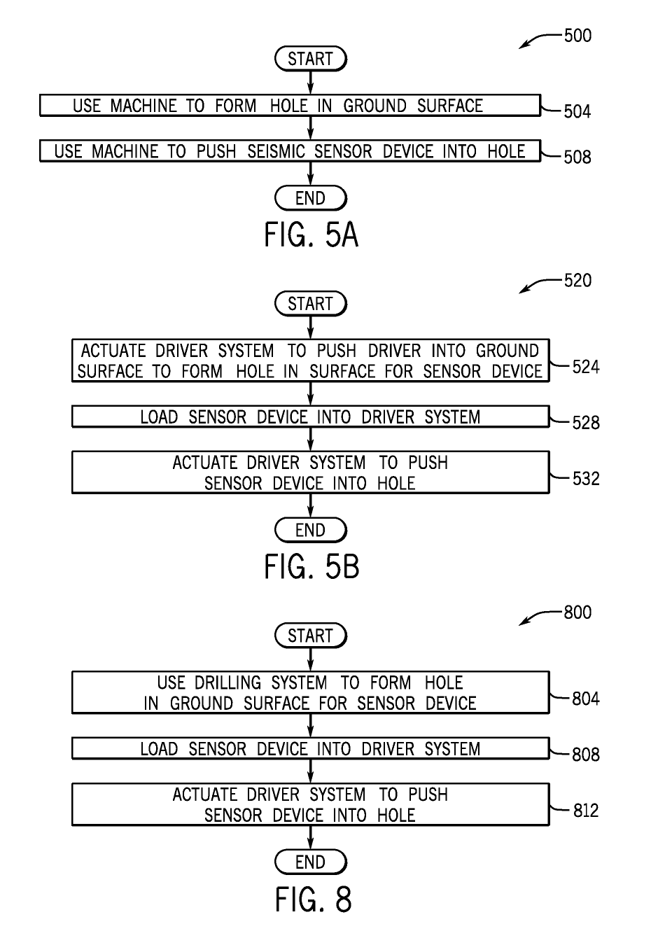

Thus, referring to FIG. 5A, in accordance with example implementations, a technique 500 for deploying a seismic sensor device includes using (block 504) a machine to form a hole in a ground surface and using (block 508) a machine to push a seismic sensor device into the hole. As described above, the same machine may be used for both purposes, i.e., hole formation and pushing of the seismic sensor device into the hole.

In this manner, referring to FIG. 5B, in accordance with example implementations, a technique 520 for deploying a seismic sensor device includes actuating (block 524) a driver system to push a driver into a ground surface to form a hole in the surface for a sensor device. The technique 520 includes loading (block 528) the sensor device into the driver system and actuating (block 532) the driver system to push the sensor device into the hole.

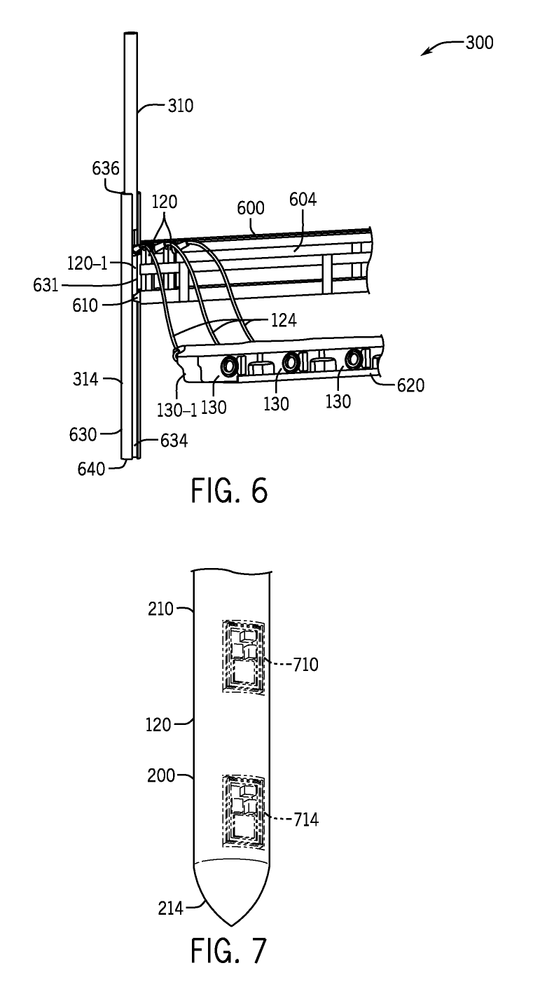

Referring to FIG. 6, in accordance with example implementations, the guide 314 includes a slotted tubing 630, which, in general, includes a longitudinal slot 634 that traverse the length of the tubing 630. The longitudinal slot 634 includes an opening 631 (an enlarged opening, in accordance with example implementations) for purposes of receiving the sensor devices 120. At its upper end 636, the tubing 630 receives the driver 310, which may be, in accordance with example implementations, a rod, or bar. The driver 310 moves through the central passageway of the tubing 630 and exits at the lower end 640 of the tubing 630.

In accordance with example implementations, the actuator 320 may be a pneumatically-driven actuator (an actuator that includes an air source or compressor; an air tank; control valves; and so forth) that produces pressurized air for purposes of driving the bar 310 downwardly through the tubing 630. More specifically, in accordance with example implementations, the actuator 320 may be coupled to the tubing 630 to, when actuated, produce a pressurized air force on a first piston surface (not shown) of the bar 310 to drive the bar 310 downwardly. Air may then be directed from the air source to another opposite facing piston surface (not shown) of the bar 310 for purposes of exerting a restoring force on the bar 310 to retract the bar 310 from the hole to the position that is depicted in FIG. 6. In further example implementations, a spring that is compressed during the driving of the bar 310 may exert a restoring force on the bar 310 to retract the bar 310 when air pressure is from an air source is released. Thus, many variations are contemplated, which are within the scope of the appended claims.

As depicted in FIG. 6, in accordance with example implementations, the sensor device deployment system 300 may include a rack 600, which guides the sensor devices 120 toward the opening 631 of the tubing 630. In this regard, the rack 600 includes a channel 604 along which the sensor devices 120 are guided in a single row toward the opening 631. Movement of the sensor devices 120, in accordance with example implementations, is aided by a conveyer belt 610 on which the sensor devices 120 rests.

As also depicted in FIG. 6, in accordance with example implementations, the sensor deployment system 300 includes another rack (not shown in FIG. 6), along which the recording units 130 slide with the associated sensor devices 120. In accordance with example implementations, movement of the recording units 130 may also be guided by a conveyer belt 620.

Thus, to deploy a given sensor device 120, the bar is first moved through the tubing 630 (via actuation of the actuator 310, which is not shown in FIG. 6) such that the bar exits the lower opening 640 and is driven, or pushed, into the ground surface to form the corresponding hole 123. The actuator 320 then reverses the direction of the bar to retract the bar above the opening 631 to prepare the tubing 630 to receive the next sensor device 120 to be deployed.

In this manner, after the lower end of the bar is raised above the opening 631, as depicted in the state shown in FIG. 6, the conveyer belt 610 is operated to move the sensor device 120 into the opening 631 and into the central passageway of the tubing 630. At this point, the conveyer belt 610 is stopped. Next, the actuator 320 is actuated to drive the bar toward the sensor device 120, thereby contacting the top of the sensor device 120 and pushing, or driving, the sensor device 120 toward the created hole 123. In this regard, translation of the bar continues until the sensor 120 exits the tubing 630 and driven into the hole 123 by the bar. During this movement of the sensor device 120 through the tubing 630, the longitudinal slot 634 allows the cable 124 to move with the sensor device 120 as the sensor device 120 is being deployed. After the sensor device 120 is pushed to the appropriate position, the actuator then withdraws the bar (i.e., moves the bar upwardly) so that the sensor deployment system 300 may be moved to the next sensor position. Before this movement occurs, the associated recording unit 130 and cable 124 is then manually or automatically deployed from the associated rack to be with the deployed sensor device 120.

Referring to FIG. 7, in accordance with example implementations, the seismic sensor device 120 may include microelectromechanical system (MEMS)-based sensors 710 and 714. As an example, one of the sensors 710, 714 may be a two component particle motion sensor that senses vertical particle motion as well as horizontal particle motion. The other sensor 710, 714, in accordance with example implementations, may sense at least horizontal particle motion.

As depicted in FIG. 7, in accordance with example implementations, the seismic sensors 710 and 714 may be spaced longitudinally apart along the elongated portion 210 of the housing 200. In this manner, when the seismic sensor 710, 714 experiences ground roll or surface horizontal movement of the ground, the horizontal particle motion sensors 710, 714 has a different reaction given the separation along the longitudinal direction on the housing 200, and therefore, the signals from horizontal particle motion sensors may be used together to derive ground roll noise, among other information. This may be used to reduce the noise in the seismic measurements.

Other variations are contemplated, which are within the scope of the appended claims. For example, in accordance with some ground conditions, the driving force produced by a driver may be insufficient to form a hole for the sensor devices 120 or form a hole having the appropriate depth. For such a case, the sensor deployment system 300 may be moved a small distance away from the planned sensor location. In the case in which the ground is in a region that is in general not suitably soft for the use of a pushing-type driving apparatus to form the hole 123, then the hole 123 may be formed using another machine. For example, referring to FIG. 8, in accordance with example implementations, a technique 800 includes using (block 804) a drilling system to form a hole in the ground surface for a seismic sensor device. Using this predrilled hole, a seismic sensor device deployment system such as the seismic sensor device deployment system 300, may then be positioned over the predrilled hole so that the sensor device may be loaded into the driver system (block 808) and the driver system may be actuated (block 812) to push the sensor device into the hole.

In accordance with further example implementations, the techniques 520 and 800 may be combined. For example, in accordance with example implementations, a drilling system may be used to form an initial relatively shallow and large diameter hole, and then the seismic sensor device deployment system may be used to drive a seismic sensor device further into the ground surface. As a more specific example, the drilling system may initially drill a hole that is relatively shallow, such as 5 to 40 centimeters (cm) in depth. This initial hole may have a diameter that is larger than the diameter of the spike portion of the seismic sensor device. Next, a seismic sensor device deployment system (such as the system 300) may be positioned over and aligned with the initial hole so that the seismic sensor device is placed into the hole and driven further into the ground surface by the system's actuator.

Thus, in accordance with example implementations, a drilling apparatus is used to form a first relatively shallow segment of a hole and a driver system is subsequently actuated to push a driver into the ground surface to form a second relatively deeper segment of the hole. The seismic sensor device may then be loaded into a guide of the driver system, and the driver system may then be actuated to push the seismic sensor device into the relatively deeper segment of the hole.

This combined drilling/driving technique may be particularly useful, for example, for the scenario in which a top layer of the ground surface is relatively unconsolidated and sandy and the layer beneath the top layer is relatively harder.

In accordance with example implementations, the guide 314 may be moveable with respect to the vehicle and/or seismic sensor device deployment system 300. In this manner, the guide 314 may be stabilized to match a desired vertical angle, such as an angle that is ten degrees vertical (as an example) or some other predetermined angle. In planting the seismic sensor devices at uniform vertical positions may be beneficial. In some terrains, such uniform placement may be challenging. By having a moveable, repositionable guide, the seismic sensor device may be placed into the ground in a vertical, or close thereto, position. The vertical adjustability of the guide may be similarly applied to any device (such as a drilling apparatus) that forms the hole for the sensor device such that the hole is formed at a suitable vertical angle.

In accordance with further example implementations, the actuator 320 may be a hydraulically-based and/or electrically-based unit. Moreover, in accordance with further example implementations the actuator 320 may use a combination of hydraulic, electrical and/or pneumatic units to generate the force(s) to drive/retract a driver of a seismic sensor device deployment system.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
using a machine to form a hole in a ground surface; and
using a machine to push a seismic sensor device into the hole.

2. The method of claim 1, wherein:
using a machine to form a hole in the ground surface comprises actuating a driver system to push a driver into the ground surface to form the hole; and
using a machine to push the seismic sensor device into the hole comprises:
loading the seismic sensor device into a guide of the driver system; and
actuating the driver system to push the seismic sensor device into the hole.

3. The method of claim 2, wherein actuating the driver system to push the seismic sensor device into the hole comprises pushing the seismic sensor device into the hole using a bar.

4. The method of claim 3, wherein actuating the driver system to push the driver into the ground surface comprises pushing the bar into the ground surface to form the hole.

5. The method of claim 2, wherein actuating the driver system to push the driver into the ground surface comprises pushing the bar into the ground surface to form the hole.

6. The method of claim 2, wherein the driver system is mounted to a vehicle, the method further comprising:
moving the driver system to a first location to deploy the seismic sensor device; and
after actuation of the driver system to push the seismic sensor device into the hole, moving the vehicle to another location at which another seismic sensor device is to be deployed.

7. The method of claim 2, wherein actuating the driver system to push the driver into the ground surface to form the hole comprises pneumatically pushing the driver into the ground surface.

8. The method of claim 2, wherein the seismic sensor device comprises a seismic sensor device of a plurality of seismic sensor devices, the method further comprising:
storing the plurality of seismic sensor devices on a rack of the driver system; and
guiding the seismic sensor devices along the rack as the seismic sensor devices are deployed.

9. The method of claim 1, further comprising:
deploying a recording unit and an associated cable between the recording unit and the seismic sensor device with the seismic sensor device.

10. The method of claim 1, wherein using a machine to form a hole in the ground surface comprises using a drilling apparatus.

11. The method of claim 1, wherein:
using a machine to form a hole in the ground surface comprises:
using a drilling apparatus to form a first relatively shallow segment of the hole and actuating a driver system to push a driver into the ground surface to form a second relatively deeper segment of the hole; and
using a machine to push the seismic sensor device into the hole comprises:
loading the seismic sensor device into a guide of the driver system; and
actuating the driver system to push the seismic sensor device into at least the relatively deeper segment of the hole.

12. An apparatus comprising:
a driver;
a guide to hold a seismic sensor device and direct the seismic sensor device along a predetermined trajectory; and
an actuator to produce a force on the driver to push the seismic sensor unit into a ground surface according to the predetermined trajectory.

13. The apparatus of claim 12, wherein the driver is adapted to be actuated by the actuator to form a hole in the ground surface before the driver pushes the seismic sensor device into the ground surface.

14. The apparatus of claim 12, wherein the guide guides the driver and the seismic sensor device as the driver pushes the seismic sensor device into the ground surface.

15. The apparatus of claim 12, further comprising a rack to guide the seismic sensor device into the driver.

16. The apparatus of claim 15, further comprising a translation mechanism to move the seismic sensor device toward the driver.

17. The apparatus of claim 12, further comprising a rack to guide a recording unit associated with the seismic sensor device with the seismic sensor device as the seismic sensor device is being deployed.

18. The apparatus of claim 12, wherein the guide comprises a tubing and the driver comprises a bar to travel inside a central passageway of the tubing.

19. The apparatus of claim 18, wherein the seismic sensor is adapted to travel inside the central passageway of the tubing.

20. The apparatus of claim 12, wherein the actuator comprises a pneumatically-driven actuator.
